(19) United States
(12) Patent Application Publication
(10) Pub. No.: US 2015/0274045 A1
(43) Pub. Date: Oct. 1, 2015

(54) UPPER SEAT MOUNT FOR ADJUSTABLE SEATS AND METHOD OF USE THEREOF

(71) Applicant: Riley Technologies, LLC, Mooresville, NC (US)

(72) Inventors: ROBERT W. RILEY, MOORESVILLE, NC (US); WILLIAM P. RILEY, MOORESVILLE, NC (US)

(73) Assignee: RILEY TECHNOLOGIES, LLC, Mooresville, NC (US)

(21) Appl. No.: 14/226,701

(22) Filed: Mar. 26, 2014

(51) Int. Cl. B60N 2/50; B60N 2/24; B60N 2/42; B60N 2/04

(52) U.S. Cl. CPC B60N 2/503; B60N 2/04; B60N 2/24; B60N 2/4235

(57) ABSTRACT

An upper seat mount for an adjustable seat includes a seat bracket, a frame attachment and an adjustable linkage. The seat bracket is attachable to the upper portion of the adjustable seat. The frame attachment is attachable to a frame for supporting the adjustable seat. The adjustable linkage interconnects the seat bracket and the frame attachment. Wherein, the adjustable linkage is adjustable between a forward position and a back position of the adjustable seat while maintaining support to the upper portion of the adjustable seat.

### CROSS-REFERENCE TO RELATED APPLICATIONS

None

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field

The disclosure generally relates to adjustable seats and mounts therefor. In particular, the instant disclosure relates to an upper seat mount for adjustable seats, like in automobiles.

2. Description of Related Art

Adjustable seats, as used herein, are seats that can at least be adjusted from forward to backward to adjust for comfort and positioning of various sized users. Typically, an adjustable seat is mounted at the bottom of the seat on tracks or rails. A seat lock may be positioned on the rails to lock the seat in a desired position. For example, the user can lift a handle underneath the seat to disengage the seat lock and slide the seat back and forth to the desired position.

One problem that has been discovered with adjustable seats is over time the top of the seats begins to flex increasingly more as the lower seat mounts wear. This flex in the top of the seat may be problematic for obvious safety reasons in addition to comfort of the driver. One solution to this wear problem has been to mount the upper portion of the seat solid to the frame that supports the adjustable seat, like the car chassis/body. However, this solution eliminates or drastically reduces the user's ability to adjust the seat. For example, fore and aft movements can only be made by removing and replacing the mount/strap at the top of the seat.

Another problem with adjustable seats is the limited protection from side impacts, which is further restricted the higher up the seat the impact occurs (i.e. the more distance from the underneath seat mount). Again, this limited protection is more problematic with additional flex in the top of the seats as the lower seat mounts wear.

Therefore, it is readily apparent that there is a recognizable unmet need for an upper seat mount for adjustable seats that provides support to the top portion of the seat while maintaining the adjustability of the seat.

### SUMMARY

Briefly described, in a preferred embodiment, the present apparatus and method overcomes the above-mentioned disadvantages and meets the recognized need for such a device by providing an upper seat mount for an adjustable seat capable of providing support to the top portion of the seat while maintaining the adjustability of the seat.

The present apparatus and method includes an upper seat mount for an adjustable seat, wherein the upper seat mount includes a seat bracket, a frame attachment and an adjustable linkage. The seat bracket is attachable to the upper portion of the adjustable seat. The frame attachment is attachable to a frame for supporting the adjustable seat. The adjustable linkage interconnects the seat bracket and the frame attachment. Wherein, the adjustable linkage is adjustable between a forward position and a back position of the adjustable seat while maintaining support to the upper portion of the adjustable seat.

One feature may be that the adjustable linkage may be a three rod linkage. The three rod linkage may provide a central moving point constrained to travel on an approximate straight line from the forward position to the back position while preventing sideways motion of the central moving point.

One embodiment of the three rod linkage may include a first rod, a second rod and a third rod. The third rod may have a linear pivot point about its middle positioned on the seat bracket. The first rod may be pivotally connected to the frame attachment at a first pivot, and pivotally connected to the third rod at a second pivot. The second rod may be pivotally connected to the frame attachment at a third pivot, and may be pivotally connected to the third rod at a fourth pivot. The third rod may be pivotally connected to the first rod at one end and pivotally connected to the second rod at the other end.

One feature may be that the first pivot, the second pivot, the third pivot, and the fourth pivot may include ball joints. Each of the ball joints may allow free movement in two planes at the same time, including rotating in those planes.

Another feature may be the seat bracket which can include an axle for the third rod to rotate about the linear pivot point of the three bar linkage. In one embodiment, the seat bracket may include a first member and a second member. The first member may be attachable to the upper portion of the adjustable seat. The second member may be attached to the first member at both ends and may have a rotation channel therebetween. Wherein, the axle may be positioned in the middle of the rotation channel.

One feature may be that the third rod can have an elongated octagonal shape with a rotation hole through its center adapted to receive the axle. Another feature may be that the third rod can have pivot holes on each of its elongated ends for attachment to the first and second rods.

One feature may be that the first member of the seat bracket can have angles for creating the rotation channel.

Another feature may be that the first member of the seat bracket can have multiple attachment holes on each end for attaching the seat bracket at various locations on the upper portion of the adjustable seat.

One feature of the frame attachment may be that it can include a first support and a second support. The first support may include or house the first pivot and may connect the first rod to the frame at a first distance from the frame. The second support may include or house the third pivot and may connect the second rod to the frame at a second distance from the frame. In one embodiment, the first distance may be greater than the second distance.

One feature may be that the first support can have a triangular shape and the second support can have a triangular shape.

The adjustable seat may include an adjustable seat, a frame for housing the adjustable seat, a lower seat mount that may be adapted to allow the seat to adjust from the forward position to the back position, and any of the various embodiments of the upper seat mount shown and described herein.

One feature may be that the adjustable seat can be used in an automobile. In one embodiment, the automobile may be a race car.

In use, a method of mounting the upper portion of an adjustable seat may utilize various embodiments of the upper seat mount as shown and described herein. The method of mounting the upper portion of an adjustable seat may include the steps of: providing the upper seat mount in any of the various embodiments shown and described herein; attaching the seat bracket of the upper seat mount to the upper portion of the adjustable seat; and attaching the frame attachment to the frame housing the adjustable seat.

These and other features of the upper seat mount for adjustable seats and its method of use thereof will become more apparent to one skilled in the art from the prior Summary, and following Brief Description of the Drawings, Detailed Description, and Claims when read in light of the accompanying Detailed Drawings.

### BRIEF DESCRIPTION OF THE DRAWINGS

The present upper seat mount device for adjustable seats will be better understood by reading the Detailed Description with reference to the accompanying drawings, which are not necessarily drawn to scale, and in which like reference numerals denote similar structure and refer to like elements throughout, and in which:

FIG. 1 is a perspective view of an exemplary embodiment of the upper seat mount with the seat partially broken away;

FIG. 2 is a side perspective view of the embodiment from FIG. 1;

FIG. 3 is another side perspective view of the embodiment from FIG. 1;

FIG. 4 is a back perspective view of the embodiment from FIG. 1;

FIG. 5 is a perspective view of an exemplary embodiment of the upper seat mount;

FIG. 6 is a front view of the embodiment from FIG. 5;

FIG. 7 is a back view of the embodiment from FIG. 5;

FIG. 8 is a top view of the embodiment from FIG. 5;

FIG. 9 is a bottom view of the embodiment from FIG. 5;

FIG. 10a is a top and front view of the embodiment from FIG. 5 in a forward position;

FIG. 10b is a top and front view of the embodiment from FIG. 5 in an intermediate position;

FIG. 10c is a top and front view of the embodiment from FIG. 5 in a back position;

FIG. 11 is a partially disassembled perspective view of the embodiment from FIG. 5;

FIG. 12 is a flow chart depicting an exemplary embodiment of the method of mounting the upper portion of an adjustable seat.

It is to be noted that the drawings presented are intended solely for the purpose of illustration and that they are, therefore, neither desired nor intended to limit the disclosure to any or all of the exact details of construction shown, except insofar as they may be deemed essential to the claimed invention.

### DETAILED DESCRIPTION

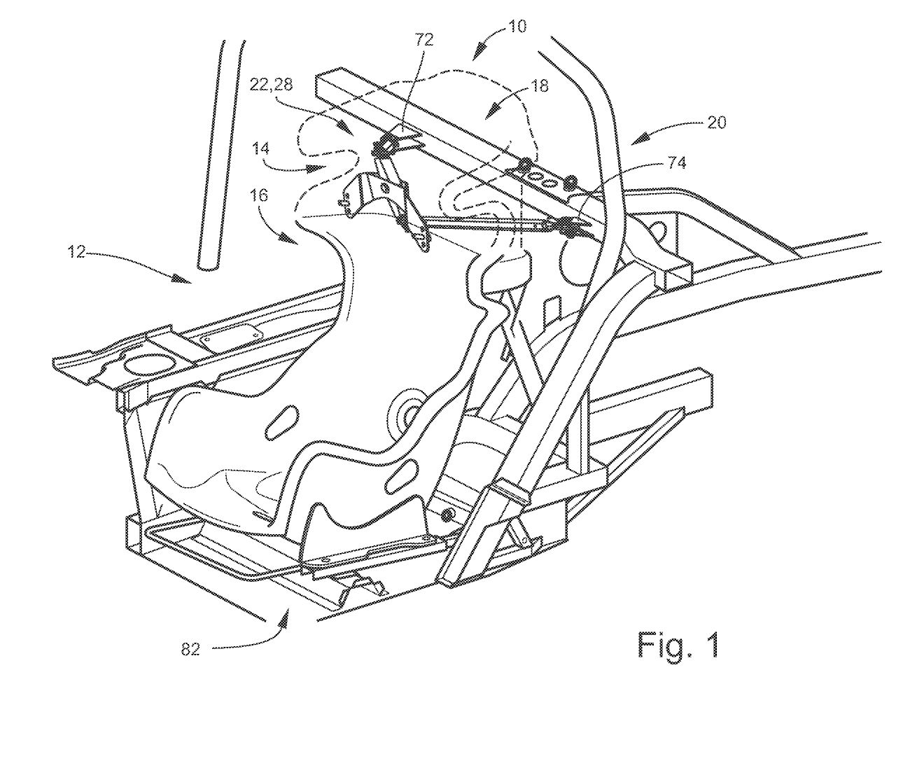

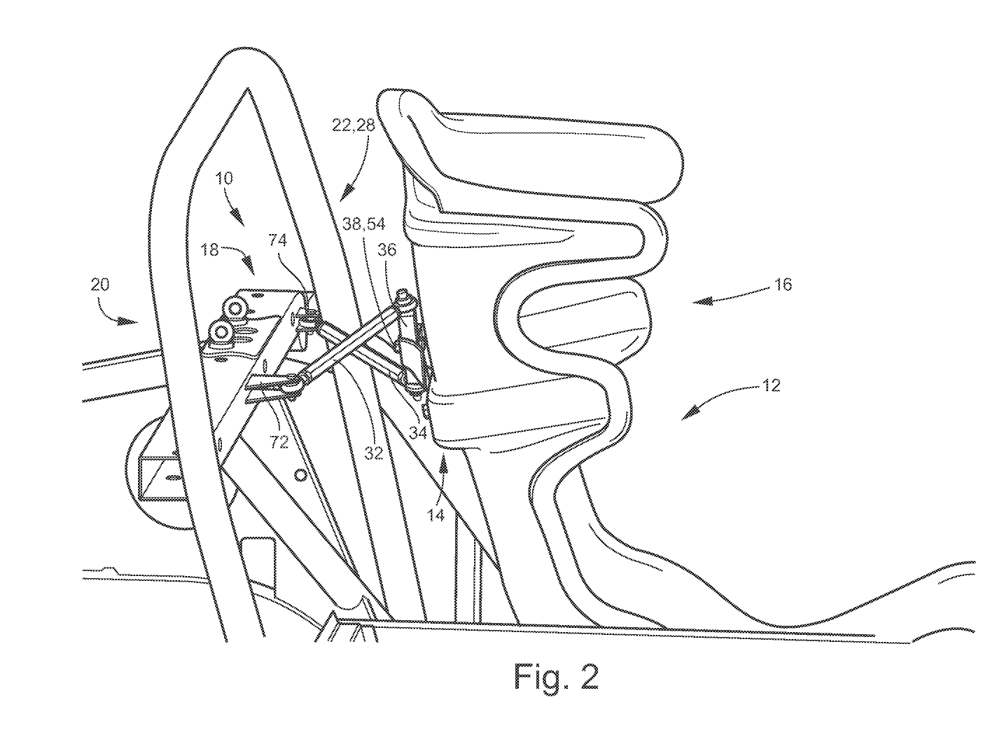

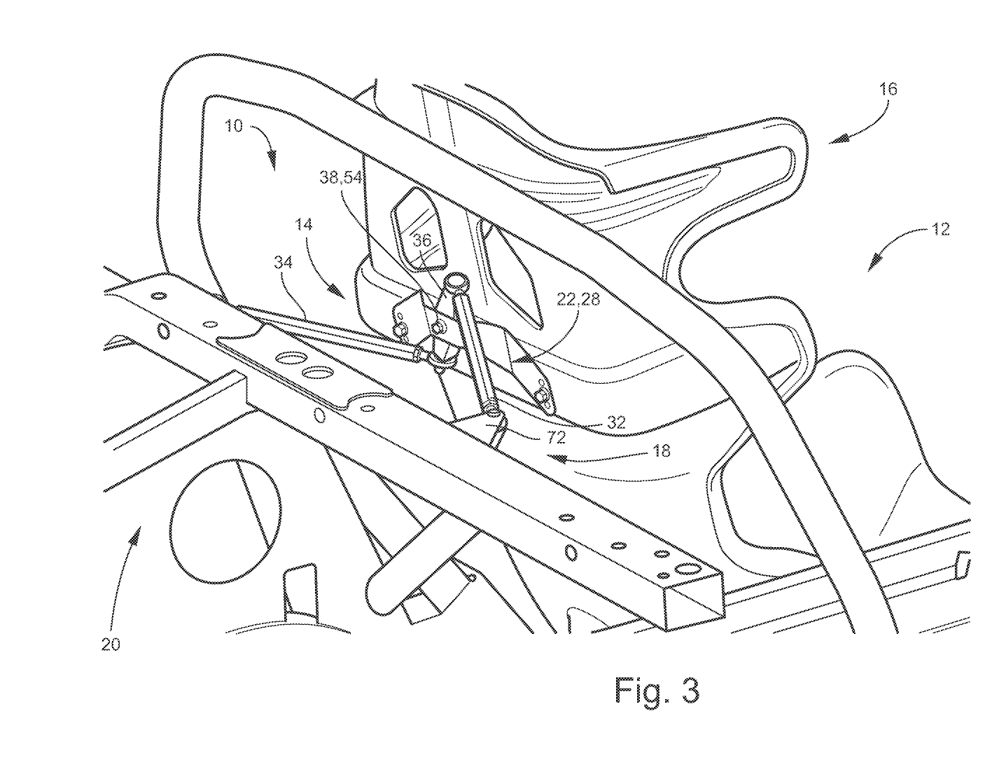

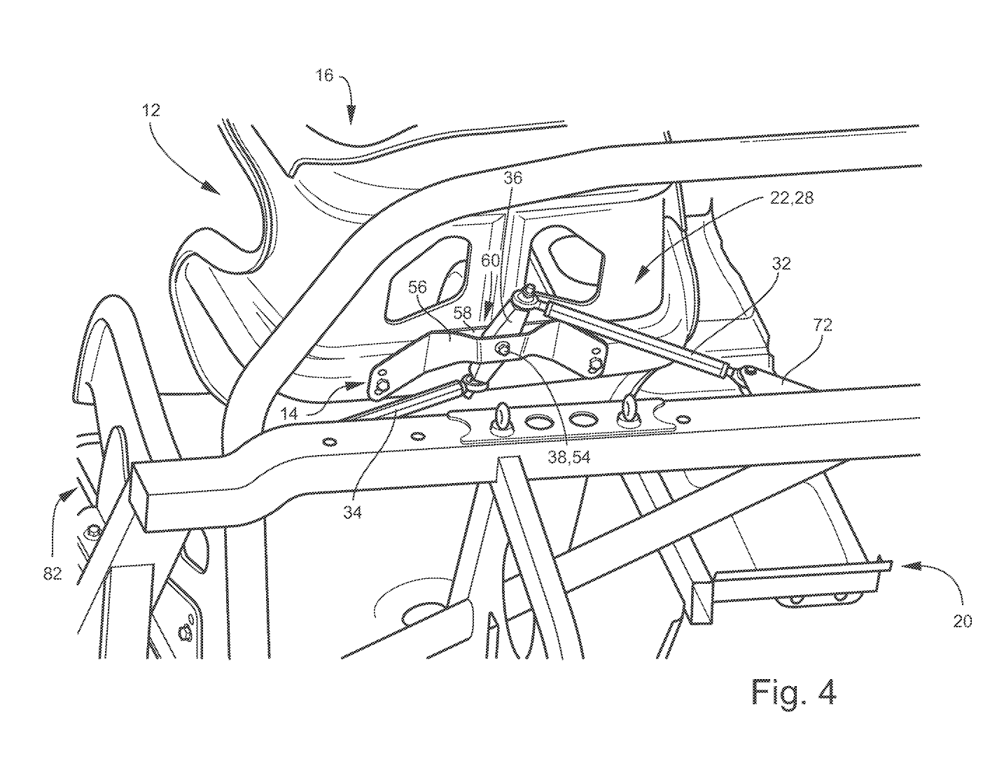

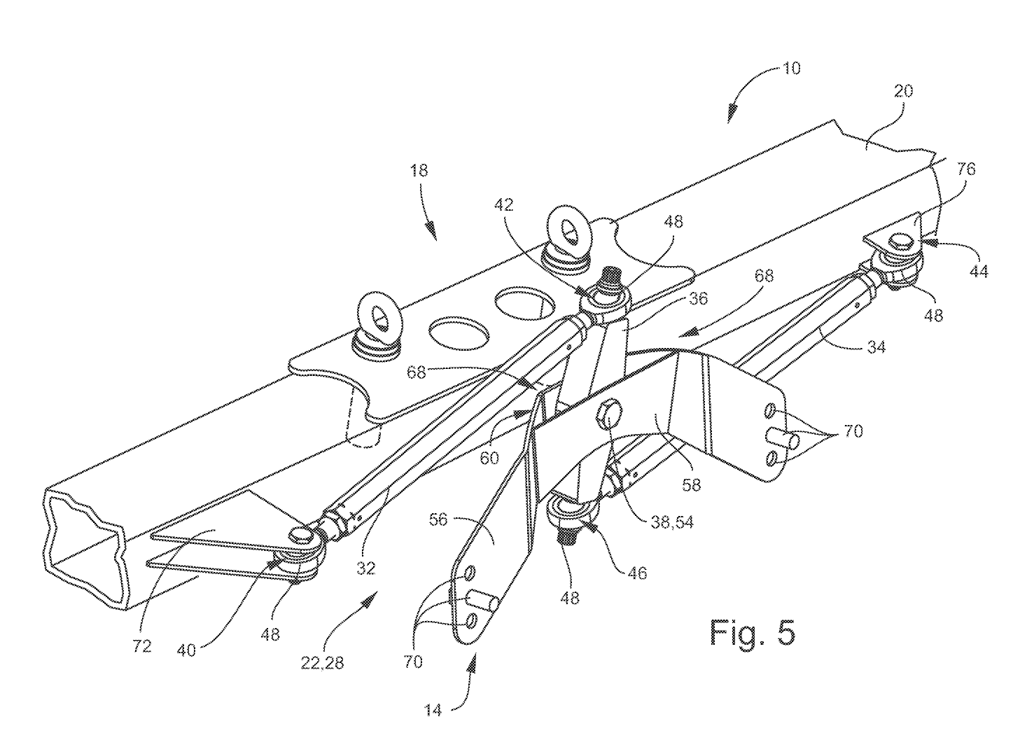

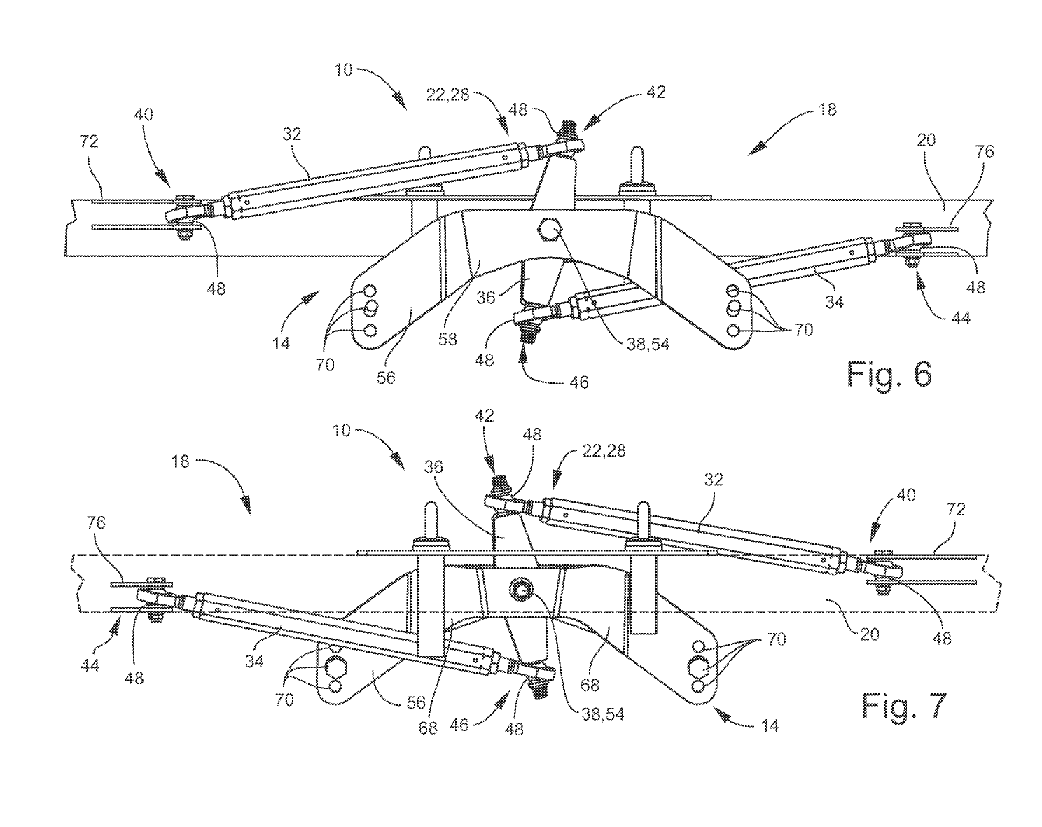

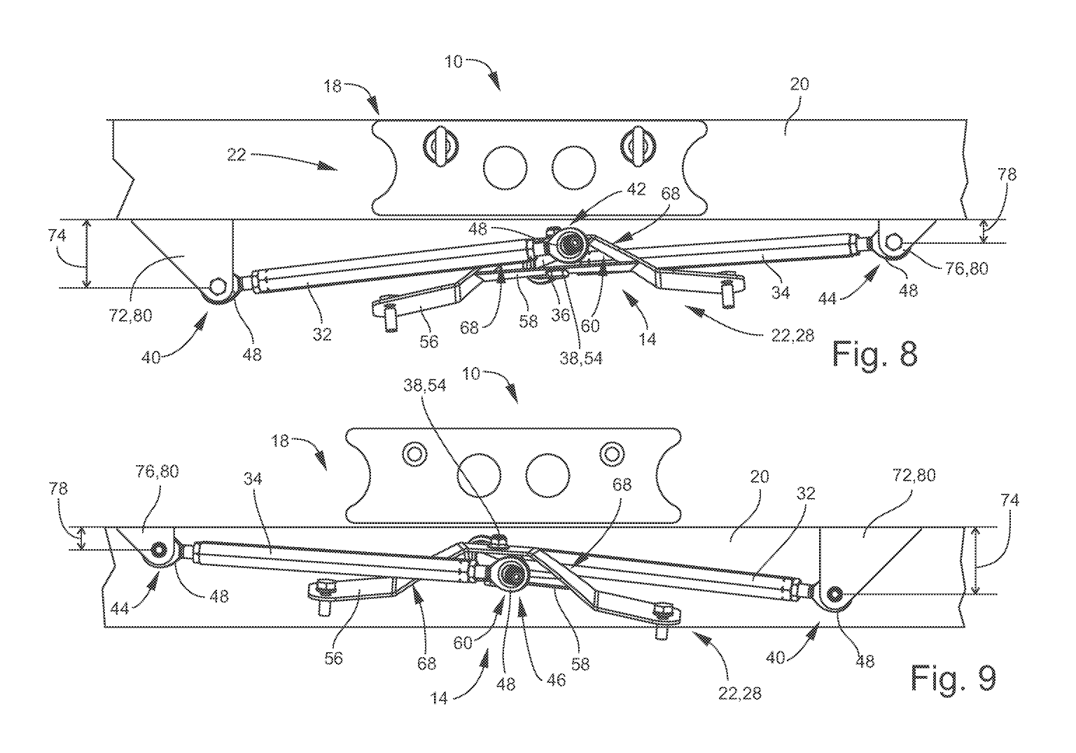

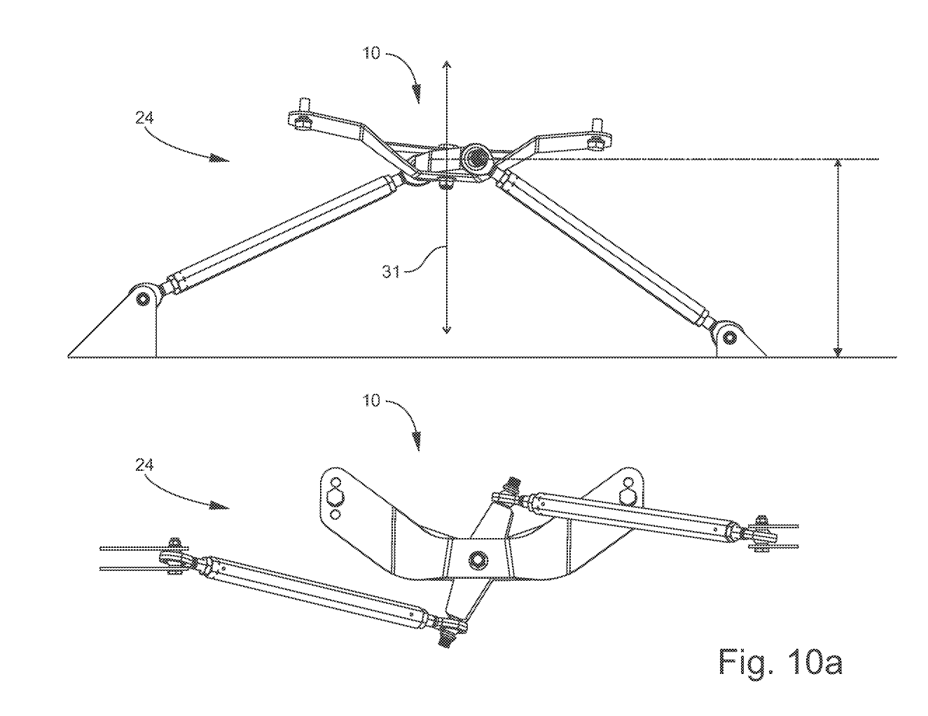

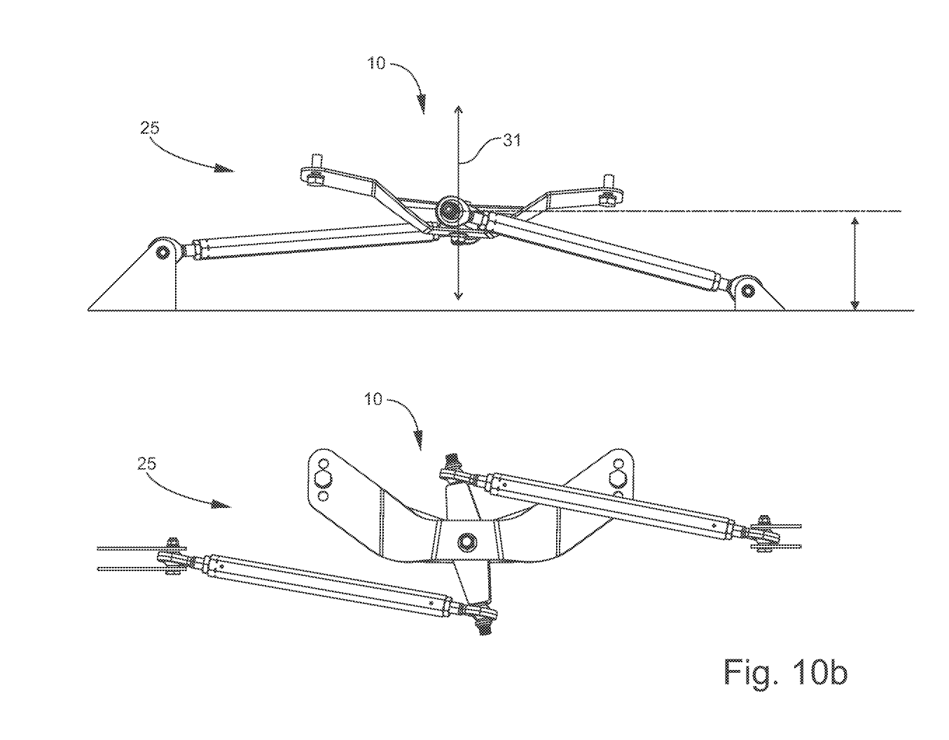

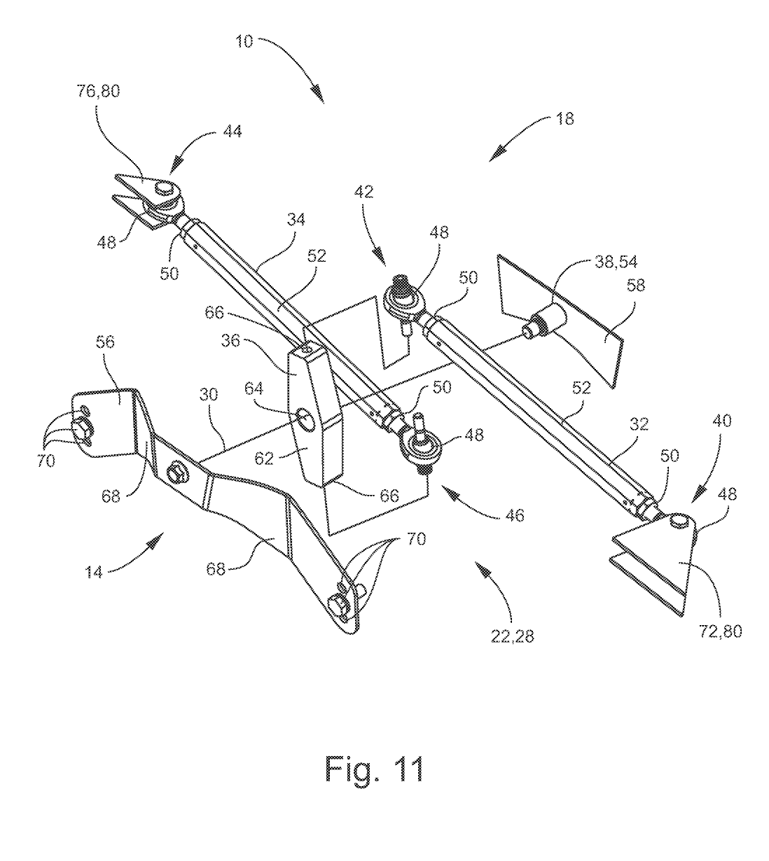

In describing the exemplary embodiments of the present disclosure, as illustrated in FIGS. 1-12, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

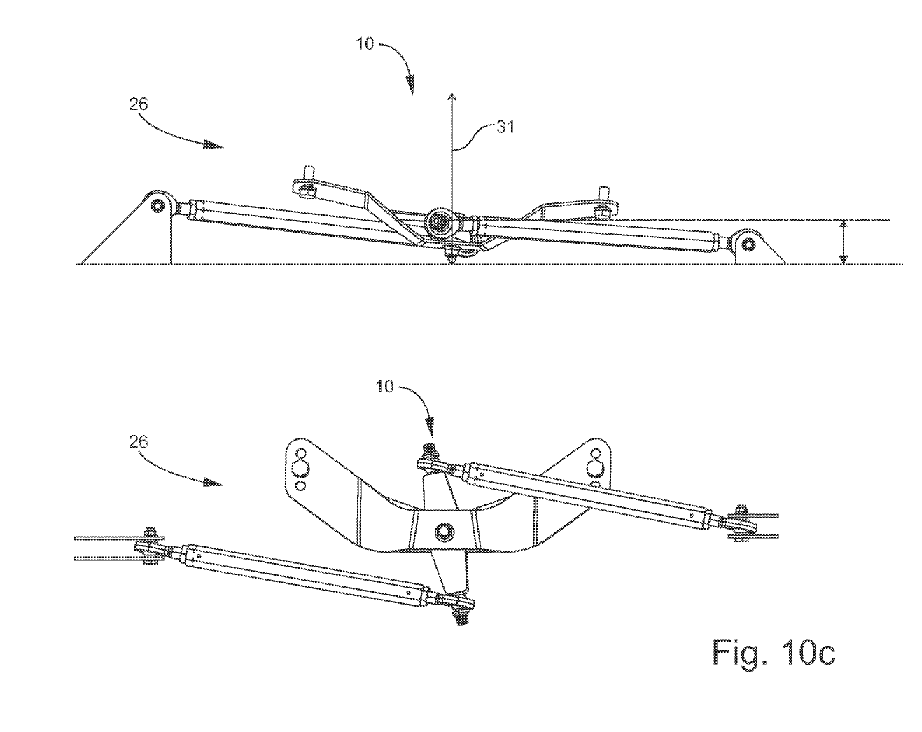

Referring now to FIGS. 1-11 by way of example, and not limitation, therein is illustrated example embodiments of upper seat mount 10 for an adjustable seat 12. As shown therein, upper seat mount 10 generally comprises seat bracket 14, frame attachment 18, and adjustable linkage 22. Seat bracket 14 may be attachable to upper portion 16 of adjustable seat 12. Frame attachment 18 may be attachable to frame 20 for supporting adjustable seat 12. Adjustable linkage 22 may interconnect seat bracket 14 and frame attachment 18. Wherein, adjustable linkage 22 can be adjustable between forward position 24 (see FIG. 10a) and back position 26 (see FIG. 10c) of adjustable seat 12 while maintaining support to upper portion 16 of adjustable seat 12. Adjustable linkage 22 can also provide for intermediate position 25 (see FIG. 10b) or multiple intermediate positions 25 between forward position 24 and back position 26.

Adjustable linkage 22 may be for providing support to upper portion 16 of adjustable seat 12 while allowing adjustable seat 12 to be adjustable. See FIGS. 1-11. Adjustable linkage 22 may be any adjustable linkage capable of providing support to upper portion 16 of adjustable seat 12 while allowing adjustable seat 12 to be adjustable. In one embodiment, as shown in the Figures, adjustable linkage 22 may be three rod linkage 28. Three rod linkage 28 may have central moving point 30 constrained to travel on approximate straight line 31 from forward position 24 to back position 26, and any intermediate position 25 or multiple intermediate positions 25 therebetween (see FIGS. 10a, 10b and 10c). Three rod linkage 28 may prevent sideways motion (i.e. motion perpendicular to approximate straight line 31, as shown in FIGS. 10a, 10b and 10c) of central moving point 30, thereby providing support to upper portion 16 of adjustable seat 12.

Three rod linkage 28 may include any construction for creating an adjustable linkage between seat bracket 14 and frame attachment 18 that provides support or prevents sideways motion. As shown in FIGS. 1-11, in one embodiment three rod linkage 28 may include first rod 32, second rod 34, and third rod 36. Third rod 36 may have linear pivot point 38 about its middle positioned on seat bracket 14. Linear pivot point 38 may provide for central moving point 30 along approximate straight line 31. In this embodiment, first rod 32 may be pivotally connected to frame attachment 18 at first pivot 40, and pivotally connected to third rod 36 at second pivot 42. Also, second rod 34 may be pivotally connected to frame attachment 18 at third pivot 44, and pivotally connected to third rod 36 at fourth pivot 46. Accordingly, third rod 36 may be pivotally connected to first rod 32 at one end and pivotally connected to second rod 34 at the other end. First pivot 40, second pivot 42, third pivot 44, and fourth pivot 46 may be any type of hinges, connections, joints, the like, etc. that allow for pivot movement between the rods. In one embodiment, first pivot 40, second pivot 42, third pivot 44, and fourth pivot 46 may include any type of hinges, connections, joints, the like, etc. that may allow free movement in two planes at the same time, including rotating in those planes. For example, as shown in FIGS. 1-11, in one embodiment, first pivot 40, second pivot 42, third pivot 44, and/or fourth pivot 46 may include ball joints 48. In this example, each of ball joints 48 may allow free movement in two planes at the same time, including rotating in those planes.

Ball joints 48, or any other hinges, connections, joints, the like, etc. may be attached to the end of the rods by any means. In one embodiment, first rod 32 and second rod 34 may have threaded end holes 50 adapted to receive ball joints 48. First rod 32 and second rod 34 may have any size, shape or cross-section. In one embodiment, as shown in FIGS. 1-11, first rod 32 and second rod 34 may have hexagonal cross-sections 52. Hexagonal cross-sections 52 may provide for grip for rotating first rod 32 and second rod 34, like by standard wrenches. In one embodiment, the rotation of first rod 32, second rod 34, and/or any of ball joints 48 may be adapted for adjusting the length between ball joints 48.

Axle 54 may be included in seat bracket 14. See FIGS. 1-11. Axle 54 may be for third rod 36 to rotate about linear pivot point 38, i.e. to rotate about central moving point 30 on approximate straight line 31. Seat bracket 14 may include any parts or designs for mounting axle 54 and linear pivot point 38 on upper portion 16 of adjustable seat 12. In one embodiment, as shown in the figures, seat bracket 14 may include first member 56 and second member 58. First member 56 may be attachable to upper portion 16 of adjustable seat 12. Second member 58 may be attached to first member 56 at both ends and may have a rotation channel 60 therebetween. In this embodiment, axle 54 may be positioned in the middle of rotation channel 60. In one embodiment, rotation channel 60 may be created by first member 56 having angles 68.

Third rod 36 may have any size, shape, or design that creates linear pivot point 38. In one embodiment, as shown in FIGS. 1-11, third rod 36 may have an elongated octagonal shape 62 with a rotation hole 64 through its center. This rotation hole 64 may provide for linear pivot point 38. As such, rotation hole 64 may be adapted to receive axle 54. Third rod 36 may also include any means for attaching to first rod 32 and second rod 34 for creating first pivot 42 and fourth pivot 46, respectively. In one embodiment, third rod 36 may include pivot holes 66 on each of its elongated ends for attachment to ball joints 48 for creating second pivot 42 and fourth pivot 46 of first and second rods 32 and 34, respectively.

Seat bracket 14 may be connected to upper portion 16 of adjustable seat 12 by any securement means, including, but not limited to, screws or the like. In one embodiment, first member 56 of seat bracket 14 may have multiple attachment holes 70 on each end for attaching seat bracket 14 at various locations on upper portion 16 of adjustable seat 12.

Frame attachment 18 may be any attachment means to frame 20 for supporting adjustable seat 12. Frame attachment 18 may include a single bracket/support or multiple brackets/supports for attachment to frame 20. In one embodiment, frame attachment 18 may include first support 72 and second support 76. First support 72 may include and/or house first pivot 40 and may connect first rod 32 to frame 20 at first distance 74 from frame 20. Second support 76 may include and/or house third pivot 44 for connecting second rod 34 to frame 20 at second distance 78 from frame 20. To create or allow for three rod linkage 28, first distance 74 may be greater than second distance 78, or vice versa. In one embodiment, first support 72 and/or second support 76 may have triangular shape 80.

Adjustable seat 12 with upper seat mount 10 may generally include the seat 12 itself, frame 20 for supporting adjustable seat 12, lower seat mount 82 adapted to allow seat 12 to adjust from forward position 24 to back position 26, and any of the embodiments of upper seat mount 10 as shown and described herein. Adjustable seat 12 may be any adjustable seat that is adapted to move from forward position 24 to back position 26. Adjustable seat 12 may also include any intermediate position 25 or multiple intermediate positions 25 between forward position 24 and back position 26. Adjustable seat 12 with upper seat mount 10 may be used in any adjustable seats that desire support in upper portion 16, including, but not limited to, vehicles, planes, trains, construction equipment, simulators, amusement rides, the like, etc. In one embodiment, adjustable seat 12 with upper seat mount 10 may be used in an automobile as an adjustable automobile seat. In another embodiment, as shown in FIGS. 1-4, adjustable seat 12 with upper seat mount 10 may be used in a race car as an adjustable race car seat.

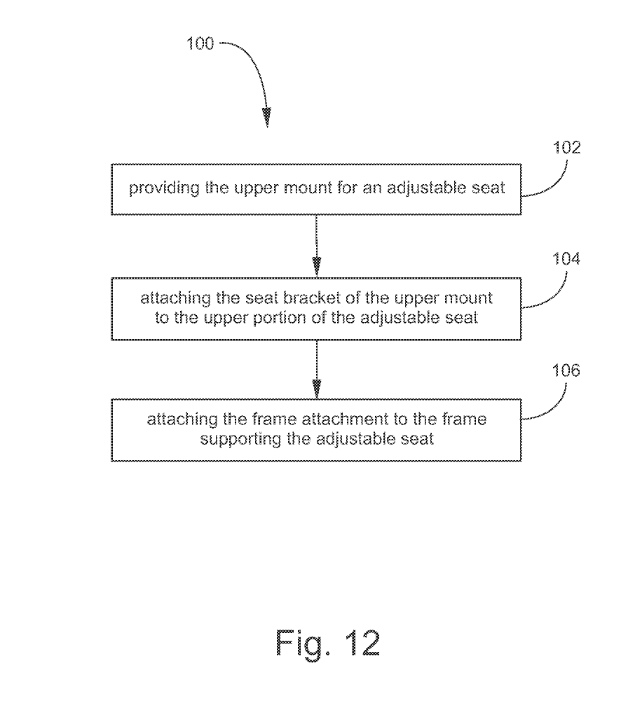

Referring now to FIG. 12, in use, method 100 of mounting upper portion 16 of adjustable seat 12 may be conducted using various embodiments of upper seat mount 10 as shown and described herein. Method 100 of mounting upper portion 16 of adjustable seat 12 may generally include the steps of: step 102 of providing upper seat mount 10 in any of the various embodiments as shown and described herein, step 104 of attaching seat bracket 14 of upper seat mount 10 to upper portion 16 of adjustable seat 12, and step 106 of attaching frame attachment 18 to frame 20 supporting adjustable seat 12.

The advantages of upper seat mount 10 with its associated adjustable seat 12 and method 100 of use thereof may be numerous, including overcoming any and/or all of the disadvantages of standard adjustable seats without upper seat mount 10. For example, upper seat mount 10 with its associated adjustable seat 12 and method 100 of use thereof may provide a device and method for supporting upper portion 16 of adjustable seat 12 while also maintaining the adjustability of seat 12. As such, upper seat mount 10 and its resulting adjustable seat 12 may reduce or prevent all together any flex that may occur from lower seat mount 82 wearing over time. In addition, upper seat mount 10 and its resulting adjustable seat 12 may provide for at least upper seat mount 10 some or added support and protection from side impacts.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation.

Accordingly, the present disclosure is not limited to the specific embodiments illustrated herein, but is limited only by the following claims.

What is claimed is:

1. An upper seat mount for an adjustable seat, wherein said upper seat mount comprises:
a seat bracket attachable to an upper portion of the adjustable seat;
a frame attachment attachable to a frame for supporting the adjustable seat; and
an adjustable linkage interconnecting said seat bracket and said frame attachment;
wherein, said adjustable linkage being adjustable between a forward position and a back position of the adjustable seat while maintaining support to the upper portion of the adjustable seat.

2. The upper seat mount for an adjustable seat of claim 1 wherein said adjustable linkage being a three rod linkage.

3. The upper seat mount for an adjustable seat of claim 2 wherein said three rod linkage having a central moving point constrained to travel on an approximate straight line from said forward position to said back position.

4. The upper seat mount for an adjustable seat of claim 2 wherein said three rod linkage preventing sideways motion of said central moving point.

5. The upper seat mount for an adjustable seat of claim 4 wherein said three rod linkage comprising:
a first rod;
a second rod; and
a third rod having a linear pivot point about its middle positioned on said seat bracket.

6. The upper seat mount for an adjustable seat of claim 5 wherein:
said first rod being pivotally connected to said frame attachment at a first pivot, and pivotally connected to said third rod at a second pivot;
said second rod being pivotally connected to said frame attachment at a third pivot, and pivotally connected to said third rod at a fourth pivot; and
said third rod being pivotally connected to said first rod at one end and pivotally connected to said second rod at the other end.

7. The upper seat mount for an adjustable seat of claim 6 wherein each of said first pivot, said second pivot, said third pivot and said fourth pivot including ball joints, each of said ball joints allowing free movement in two planes at the same time, including rotating in those planes.

8. The upper seat mount for an adjustable seat of claim 5 wherein said seat bracket including an axle for said third rod to rotate about said linear pivot point.

9. The upper seat mount for an adjustable seat of claim 8 wherein said seat bracket comprising:
a first member attachable to the upper portion of the adjustable seat;
a second member attached to said first member at both ends and having a rotation channel therebetween;
wherein, said axle being positioned in the middle of said rotation channel.

10. The upper seat mount for an adjustable seat of claim 9 wherein said third rod having an elongated octagonal shape with a rotation hole through its center for said axle, and pivot holes on each of its elongated ends for attachment to said first and second rods.

11. The upper seat mount for an adjustable seat of claim 10 wherein said first member having angles to create said rotation channel.

12. The upper seat mount for an adjustable seat of claim 10 wherein said first member of said seat bracket having multiple attachment holes on each end for attaching said seat bracket at various locations on the upper portion of the adjustable seat.

13. The upper seat mount for an adjustable seat of claim 6 wherein said frame attachment comprising:
a first support including said first pivot and connecting said first rod to said frame at a first distance from said frame; and
a second support including said third pivot for connecting said second rod to said frame at a second distance from said frame;
wherein, said first distance being greater than said second distance.

14. An adjustable seat with an upper seat mount comprises:
a seat with an upper portion;
a frame for supporting said seat;
a lower seat mount to allow said seat to adjust from a forward position to a back position; and
an upper seat mount, said upper seat mount comprises:
a seat bracket attachable to the upper portion of the seat;
a frame attachment attachable to the frame; and
an adjustable linkage interconnecting said seat bracket and said frame attachment;
wherein, said adjustable linkage being adjustable between a forward position and a back position of the adjustable seat while maintaining support to the upper portion of the seat.

15. The adjustable seat with an upper seat mount of claim 14 wherein said adjustable linkage being a three rod linkage.

16. The adjustable seat with an upper seat mount of claim 15 wherein said three rod linkage comprising:
a first rod;
a second rod; and
a third rod having a linear pivot point about its middle positioned on said seat bracket;
said first rod being pivotally connected to said frame attachment at a first pivot, and pivotally connected to said third rod at a second pivot;
said second rod being pivotally connected to said frame attachment at a third pivot, and pivotally connected to said third rod at a fourth pivot; and
said third rod being pivotally connected to said first rod at one end and pivotally connected to said second rod at the other end.

17. The adjustable seat with an upper seat mount of claim 16 wherein:
each of said first pivot, said second pivot, said third pivot and said fourth pivot including ball joints, each of said ball joints allowing free movement in two planes at the same time, including rotating in those planes;
said first rod and said second rod having threaded end holes to receive said ball joints,
said first rod and said second rod having hexagonal cross-sections for rotating said first and said second rod, whereby, said first and said second rods being rotatable for adjusting the length between said ball joints;
said seat bracket including an axle for said third rod to rotate about said linear pivot point;
said seat bracket comprising:
a first member attachable to the upper portion of the seat;
a second member attached to said first member at both ends and having a rotation channel therebetween;
wherein, said axle being positioned in the middle of said rotation channel;
said third rod having an elongated octagonal shape with a rotation hole through its center to receive said axle, and pivot holes on each of its elongated ends for attachment to said first and second rods;
said first member having angles to create said rotation channel;
said first member of said seat bracket having multiple attachment holes on each end for attaching said seat bracket at various locations on the upper portion of the adjustable seat;
said frame attachment comprising:
a first support including said first pivot and connecting said first rod to said frame at a first distance from said frame; and
a second support including said third pivot for connecting said second rod to said frame at a second distance from said frame;
wherein, said first distance being greater than said second distance; and
said first support having a triangular shape and said second support having a triangular shape.

18. The adjustable seat with an upper seat mount of claim 14 wherein said adjustable seat being used in an automobile.

19. The adjustable seat with an upper seat mount of claim 18 wherein said automobile being a race car.

20. A method of supporting an upper portion of an adjustable seat comprising the steps of:
providing an upper seat mount, said upper seat mount comprises:
a seat bracket attachable to the upper portion of the adjustable seat;
a frame attachment attachable to a frame for housing the adjustable seat; and
an adjustable linkage interconnecting said seat bracket and said frame attachment;
wherein, said adjustable linkage being adjustable between a forward position and a back position of the adjustable seat while maintaining support to the upper portion of the adjustable seat;
attaching the seat bracket of the upper seat mount to the upper portion of the adjustable seat; and
attaching the frame attachment to a frame supporting the adjustable seat.
